(19) United States
(12) Patent Application Publication
(10) Pub. No.: US 2017/0249870 A1
(43) Pub. Date: Aug. 31, 2017

(54) CUSTOMIZED NECK RESPONSE FINITE ELEMENT MODEL FOR CRASH TEST DUMMY AND METHOD

(71) Applicant: Humanetics Innovative Solutions, Inc., Plymouth, MI (US)

(72) Inventor: Chirag Shah, Plymouth, MI (US)

(21) Appl. No.: 15/445,460

(22) Filed: Feb. 28, 2017

Related U.S. Application Data
(60) Provisional application No. 62/301,396, filed on Feb. 29, 2016.

(51) Int. Cl. G09B 23/32; G09B 9/00

(52) U.S. Cl. CPC G09B 23/32; G09B 9/00

(57) ABSTRACT

A customized neck response finite element model for a neck of a crash test dummy is disclosed. A method of creating the customized neck response finite element model for the neck of the crash test dummy including the steps of identifying two borderline sets of test data profiles for the neck that match with certification test data profiles for the neck of the crash test dummy, varying material properties of components of the neck for the crash test dummy, defining a mapping function to adjust the material properties and allowing intermediate sets of the test data profiles to be interpolated from the certification test data profiles, and creating a single neck response finite element model for the neck of the crash test dummy with a user-defined input parameter for the neck response finite element model that defines a customized response.

### CROSS-REFERENCE TO RELATED APPLICATION(S)

The present application claims the benefit of pending U.S. Provisional Patent Application Ser. No. 62/301,396, filed Feb. 29, 2016, the entire disclosure of which is hereby expressly incorporated by reference.

### BACKGROUND OF THE INVENTION

1. Field of the Invention

The present invention relates generally to crash test dummies and, more particularly, to a customized neck response finite element model for a crash test dummy and method of creating the customized neck response finite element model.

2. Description of the Related Art

Automotive, aviation, and other vehicle manufacturers conduct a wide variety of collision testing to measure the effects of a collision on a vehicle and its occupants. Through collision testing, a vehicle manufacturer gains valuable information that can be used to improve the vehicle, authorities examine vehicles to submit type approval, and consumer organizations provide information on vehicle safety ratings to the public.

Collision testing often involves the use of anthropomorphic test devices, better known as “crash test dummies”, to estimate a human's injury risk. The dummy must possess the general mechanical properties, dimensions, masses, joints, and joint stiffness of the humans of interest. In addition, they must possess sufficient mechanical impact response similitude and sensitivity to cause them to interact with the vehicle's interior in a human-like manner.

The crash test dummy typically includes a head assembly, spine assembly (including neck), rib cage assembly, abdomen, pelvis assembly, right and left arm assemblies, and right and left leg assemblies. Generally, the arm assembly has an upper arm assembly and a lower arm assembly. The upper arm assembly is typically connected to a shoulder assembly, which, in turn, is typically connected to the spine assembly.

Currently, there is dummy-to-dummy variability seen in neck rotation and moment arm measured at a head and neck joint (also known as occipital condyle joint) of physical crash test dummies in certification, sled, and vehicle testing due to differences in materials, manufacturing, and environment. As a result, there is a need in the art for a neck finite element model to enable users to adjust a stiffness of a neck based on their hardware or physical crash test dummy so as to quantify its characteristics from a neck pendulum certification level to their sled or vehicle environment. There is also a need in the art for a neck finite element model that not only captures a phenomenon of variability, but also allows users to perform robustness studies using extremes of certification corridors. Thus, there is a need in the art for a customized neck response finite element model for a crash test dummy and method of creating the customized neck response finite element model that meets at least one of these needs.

### SUMMARY OF THE INVENTION

Accordingly, the present invention provides a customized neck response finite element model for a neck of a crash test dummy. The present invention also provides a method of creating a customized neck response finite element model for the neck of the crash test dummy including the steps of identifying two borderline sets of test data profiles of the neck that match with certification test data profiles for the neck of the crash test dummy, varying material properties of components of the neck for the crash test dummy, defining a mapping function to adjust the material properties and allowing intermediate sets of the test data profiles to be interpolated from the certification test data profiles, and creating a single neck response finite element model for the neck of the crash test dummy with a user-defined input parameter for the neck response finite element model that defines a customized response.

One advantage of the present invention is that a new customized neck response finite element model and method is provided for a crash test dummy. Another advantage of the present invention is that the customized neck response finite element model and method provides a customized neck finite element model that bridges a gap between reality and simulation by better capturing hardware behavior, and lays a framework for future models applicable to other parts. Yet another advantage of the present invention is that the customized neck response finite element model and method enables users to adjust a stiffness and contact algorithm parameters of a neck based on their hardware test dummy so as to quantify its characteristics from a neck pendulum certification level to their sled or vehicle environment. Still another advantage of the present invention is that the customized neck response finite element model and method not only captures the phenomenon of variability, but also allows users to perform robustness studies using extremes of certification corridors.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an elevational view of one embodiment of a crash test dummy.

FIGS. 2A-2C are diagrammatic views of a customized neck response finite element model, according to one embodiment of the present invention, for the crash test dummy of FIG. 1.

FIGS. 3A-3C are elevational views of a neck pendulum in flexion impact test, neck pendulum in extension impact test, and an apparatus for neck pendulum impact testing, respectively, for a neck of the crash test dummy of FIG. 1.

FIGS. 4A-4C are graphical views of one example of an upper neck load-cell shear force, occipital condyle moment, and D-Plane rotation, respectively, for the neck pendulum in flexion impact test of FIG. 3A.

FIGS. 5A-5C are graphical views of another example of an upper neck load-cell shear force, occipital condyle moment, and D-Plane rotation, respectively, for the neck pendulum in flexion impact test of FIG. 3A.

### DESCRIPTION OF THE PREFERRED EMBODIMENT(S)

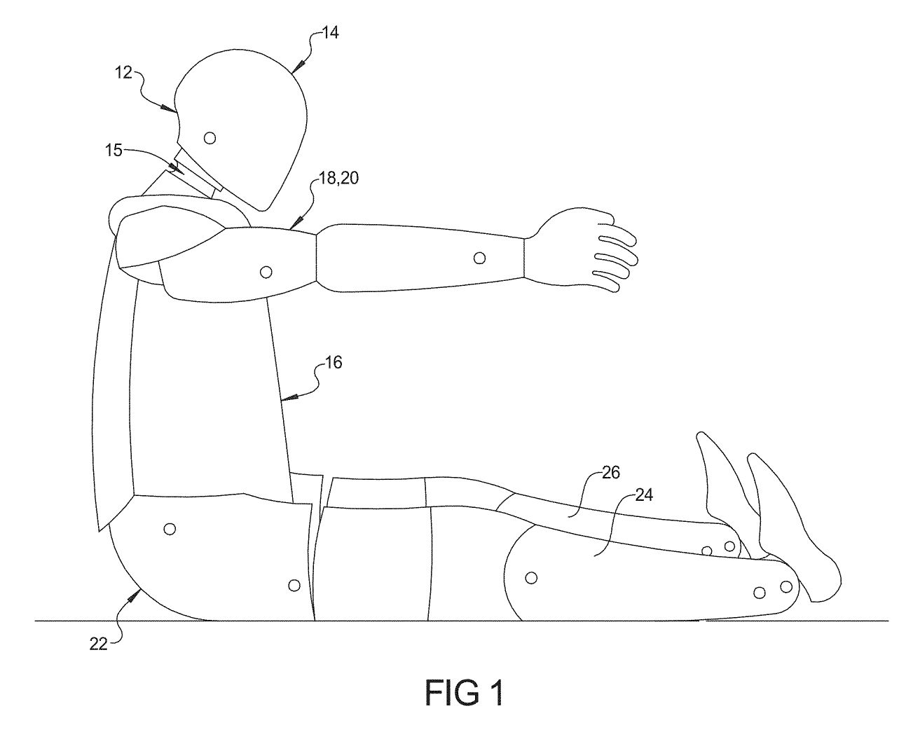

Referring to the drawings and in particular FIG. 1, one embodiment of a crash test dummy, according to the present invention, is generally indicated at 12. The crash test dummy 12 is of a fiftieth percentile (50%) male type and is illustrated in a seated position. This crash test dummy 12 is used primarily to test the performance of automotive interiors and restraint systems for front and rear seat occupants. The size and weight of the crash test dummy 12 are based on anthropometric studies, which are typically done separately by the following organizations, University of Michigan Transportation Research Institute (UMTRI), U.S. Military Anthropometry Survey (ANSUR), and Civilian American and European Surface Anthropometry Resource (CESAR). It should be appreciated that ranges of motions, centers of gravity, and segment masses simulate those of human subjects defined by the anthropometric data.

As illustrated in FIG. 1, the crash test dummy 12 includes a head assembly, generally indicated at 14. The crash test dummy 12 also includes a neck assembly, generally indicated at 15, having an upper end mounted to the head assembly 14 and a lower end mounted to a spine assembly (not shown) extending into a torso area of the crash test dummy 12. It should be appreciated that an example of a neck assembly for a crash test dummy is disclosed in U.S. patent application Ser. No. 14/981,034, filed Dec. 28, 2015, to Wang, the disclosure of which is hereby incorporated in its entirety by reference.

The torso area of the crash test dummy 12 also includes a rib cage or torso assembly, generally indicated at 16, connected to the spine assembly. The crash test dummy 12 also has a pair of arm assemblies including a right arm assembly, generally indicated at 18, and a left arm assembly, generally indicated at 20, which are attached to the spine assembly of the crash test dummy 12. It should be appreciated that a lower end of the spine assembly is connected to a lumbar-thoracic adapter (not shown), which is connected to a lumbar to pelvic adapter (not shown). It should also be appreciated that the neck assembly 15 may be part of the spine assembly.

As illustrated in the FIG. 1, the crash test dummy 12 includes a pelvis assembly, generally indicated at 22, connected to the adapter. The crash test dummy 12 includes a right leg assembly 24 and a left leg assembly 26, which are attached to the pelvis assembly 22. It should be appreciated that various components of the crash test dummy 12 may be covered in a polyvinyl skin such as a flesh and skin assembly for biofidelity of the crash test dummy 12.

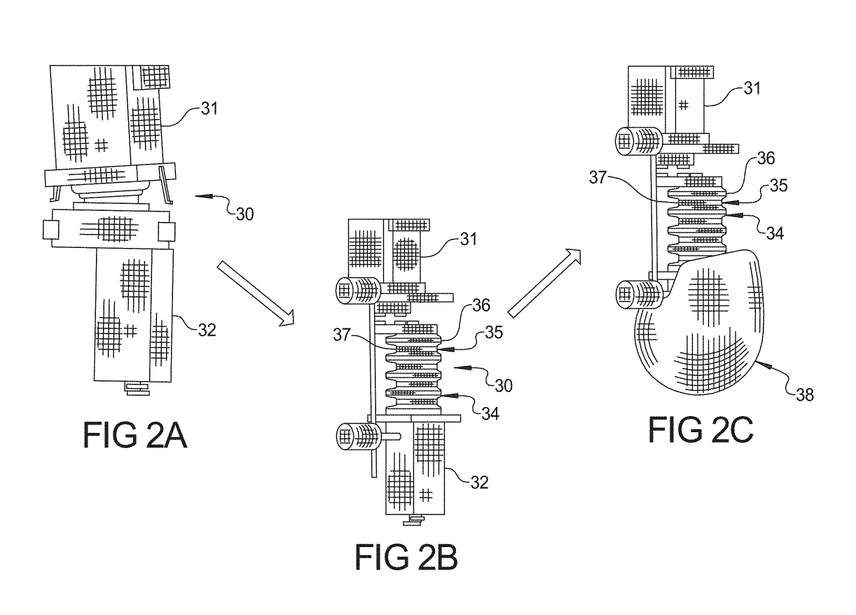

Referring to FIGS. 2A-2C, one embodiment of a customized neck response finite element model, according to the present invention and generally indicated at 30, is disclosed for the neck assembly 15 of the crash test dummy 12. The model 30 is to be carried out on a computer system that includes a computer having a memory, a processor, a display and user input mechanism, such as a mouse or keyboard (not shown). The model 30 is implemented on the computer system in MATLAB, which is commercially available from MathWorks, coupled with other lower level languages. Efficient numerical algorithms (Genetic Algorithm) are used and coded, making it possible that a complete analysis can be done within minutes on a Pentium computer of the computer system. It should be appreciated that the computer system is conventional and known in the art.

As illustrated in FIGS. 2A-2C, the customized neck response finite element model is generally indicated at 30. As illustrated in FIG. 2A, the customized neck response finite element model 30 includes an upper mount 31 and a lower mount 32. As illustrated in FIG. 2B, the customized neck response finite element model 30 also includes a neck assembly 34 disposed between the upper mount 31 and the lower mount 32 and includes a plurality of modular vertebra segments, generally indicated at 35. In the embodiment illustrated, the neck assembly 34 has four (4) cervical spine vertebra segments 35. Each vertebra segment 35 includes a vertebra disc 36 having a height or thickness corresponding to its location in the cervical of the neck assembly 34. In one embodiment, the vertebra disc 36 is made of a relatively rigid material such as metal or plastic. The vertebra disc 36 is generally circular in shape, but may be any suitable shape to simulate a human neck. Each vertebra segment 35 includes a ligament joint element 37 disposed between adjacent vertebra discs 36. In the embodiment illustrated, one ligament joint element 37 is disposed between a pair of vertebra discs 36. As illustrated, each ligament joint element 37 is disposed between a pair of the vertebra discs 36. In one embodiment, the ligament joint element 37 is made of a relatively flexible material such as an elastomeric material, for example, rubber. The customized neck response finite element model 30 includes a neck rubber and neck cable (not shown) representing nominal, soft, and stiff response of the neck assembly 34 of the finite element model 30 for the crash test dummy 12. To construct the customized neck response finite element model 30, all levels of neck correlation are evaluated to ensure that the response was reasonable. As illustrated in FIG. 2C, the customized neck response finite element model 30 includes the neck assembly 34 and a head assembly 38 mounted to the lower mount 32. It should be appreciated that the neck hardware of the crash test dummy 12 includes complex structural components involving rubber segments, nodding block, neck cable, and transducers to measure the force and moment arm at the occipital condyle and neck rotation measurements.

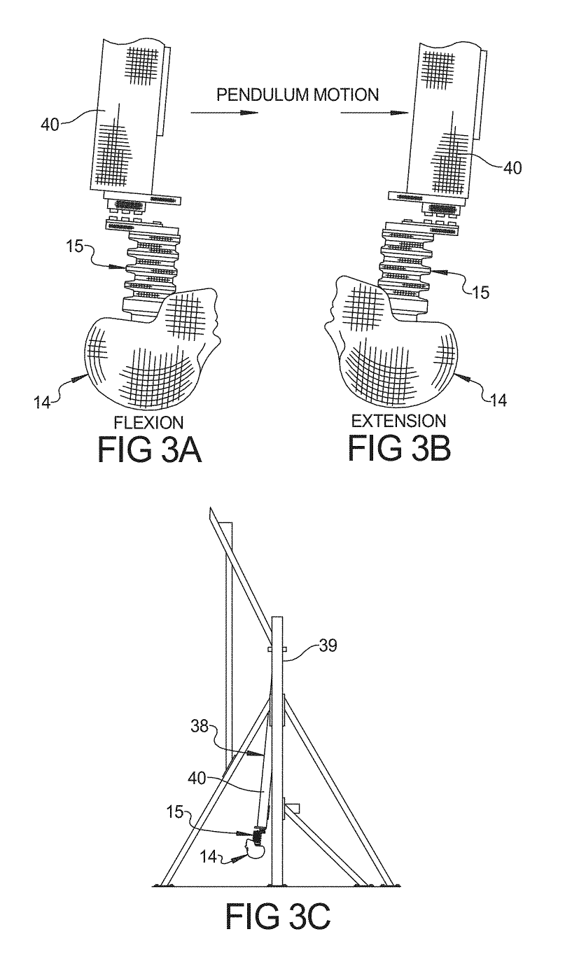

Referring to FIG. 3C, an apparatus, generally indicated at 38, for neck pendulum impact testing for neck pendulum certification tests of the neck assembly 15 for the crash test dummy 12 is shown. The apparatus 38 includes a frame 39 for the neck assembly 15 and head assembly 14 of the crash test dummy 12. The apparatus 38 also includes a pendulum 40 pivotally connected to the frame 39. As illustrated, the pendulum 40 has one end that produces the flexion of the neck assembly 15 as illustrated in FIG. 3A and the extension of the neck assembly 15 as illustrated in FIG. 3B. In one embodiment, the pendulum 40 produces a neck pendulum extension impact test at an impact speed, for example, of 6.07 m/s and a neck pendulum flexion impact test at an impact speed, for example, of 7.01 m/s. The D-plane rotations are measured using two rotary pot sensors (not shown) installed in hardware during the test. The condyle moment is calculated from the upper neck load cell sensor moment installed during the test. It should be appreciated that the finite element model 30 mimics these sensors exactly to get the corresponding values for the model. It should be appreciated that a neck extension mode allows for a 25 degrees spread in D-Plane rotation of the neck assembly 15.

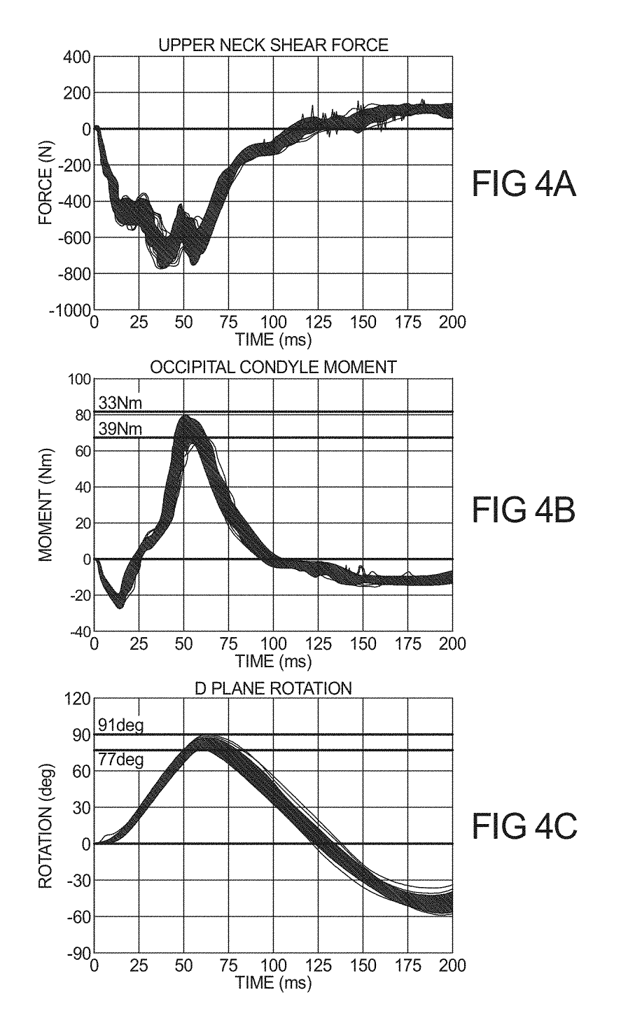

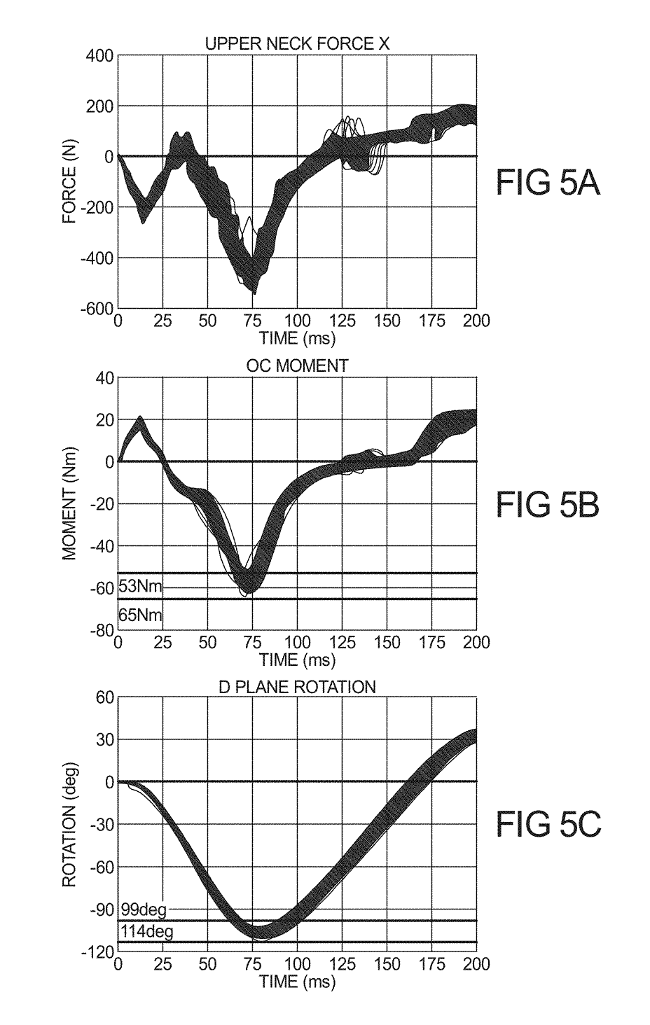

For creating the customized neck response finite element model 30, one embodiment of a method, according to the present invention, includes the step of identifying two borderline sets of test data profiles (e.g., FIGS. 4A-4C and 5A-5C) that matched reasonably well with extreme certification test data profiles of the neck assembly 15 using the apparatus 38. For example, two borderline sets of the test data profiles that match with variability at controlled component testing of the neck assembly 15 were identified. For example, minimizing the peak value differences between the test and finite element model values. It should be appreciated that the smaller a gap (error) between two values, the better the model is. It should also be appreciated that, in principle, the target is to match the model and test peak values exactly.

The method also includes the step of varying material properties of key components of the neck assembly 34 and/or varying finite element contact parameters such as contact friction of the components of the neck assembly 34. For example, varying material properties of the ligament joint element 37. The method further includes the step of defining a mapping function to adjust the material properties and allowing intermediate sets of the test data profiles to be interpolated from extremes of the certification corridors, thus matching a best match to any certification. For example, the mapping function adjusts the materials such as material properties and contacts such as contact parameters in the finite element model 30 to minimize the gap (error) between the input test peak value and the output test peak value of the same parameter in the model.

The method further includes the step of creating a single neck response finite element model 30 for the crash test dummy 12 with a user-defined ‘input parameter’ for the neck response finite element model 30 that defines a ‘customized’ response, which is equal to a neck D-plane rotation peak seen at the certification level for the neck assembly 15 using the apparatus 38. The model 30 then internally calibrates material cards of components of the neck assembly 34 using a parameter script to reproduce a certification neck D-plane rotation of a specified input. For example, the input parameter is the neck rotation (D-plane rotation) from the test. It should be appreciated that a method of modeling for crash test dummy finite element models is disclosed in U.S. Pat. No. 9,043,187 to Pang, the disclosure of which is hereby incorporated in its entirety by reference.

The neck D-plane rotation is set between a maximum value and a minimum value of the certification corridors with a default value to an average value of the extension neck certification tests of the neck assembly 15 for the crash test dummy 12. In one embodiment, the D-Plane rotation is a default value corresponding to an average value of neck pendulum extension certification tests of the neck assembly 15 for the crash test dummy 12. It should be appreciated that a default (example) value will be in the middle of the certification corridors. It should also be appreciated that a focus in development was in a neck pendulum case where there was a larger variety of data which ensured that the finite element model 30 captured a wide range of physical test dummies such as the crash test dummy 12.

The method may also include the step of varying finite element contact algorithm parameters of the neck response finite element model 30 for components of the neck assembly 34. For example, the finite element contact parameters are a coefficient of friction. It should be appreciated that this parameter controls the resistance (force) when the two finite element model surfaces are rubbed (or slid) against each other.

As previously described, there is dummy-to-dummy variability seen in the neck D-plane rotation in physical crash test dummies (in certification, sled and vehicle tests) such as the crash test dummy 12 due to differences in material, manufacturing, environment, aging effect and other factors.

As illustrated in FIGS. 4A-4C, an upper neck shear force, upper neck moment arm, and D-Plane rotation is shown for the neck pendulum flexion impact test of the neck assembly 15 at 7.01 m/s. As illustrated in FIGS. 5A-5C, an upper neck shear force, upper neck moment arm, and D-Plane rotation is shown for the neck pendulum extension impact test of the neck assembly 15 at 6.07 m/s. The customized neck response finite element model 30 allows adjustment of a stiffness of the neck assembly 15 based on the physical hardware of the crash test dummy 12, which might range from stiff at one end of the certification corridor to soft at another end of the certification corridor. It should be appreciated that a system for modeling dynamic response changes in an anthropomorphic dummy is disclosed in U.S. Pat. No. 8,407,033 to Cooper et al., the disclosure of which is hereby incorporated in its entirety by reference. It should also be appreciated that this customization, based on certification test data from the physical crash test dummy 12, enables the user to accurately quantify or predict the D-Plane rotation and condyle moment for the neck assembly 15 of the crash test dummy 12 at the sled or vehicular level.

The reliability of the customized neck response finite element model 30 was validated across numerous component, sled, and vehicle load cases. It should be appreciated that, although the customized neck response finite element model 30 was developed for a particular brand of crash test dummies 12, through customization, the finite element model 30 can accurately represent the D-plane rotation and upper neck condyle moment for any neck for the crash test dummy 12.

In one embodiment, a method, according to the present invention, of creating a customized neck response finite element model 30 for a neck of the crash test dummy 12 includes the steps of identifying two borderline sets of test data profiles that match with certification test data profiles for the neck of the crash test dummy 12, varying material properties of components of the neck for the crash test dummy 12, defining a mapping function to adjust the material properties and allowing intermediate sets of the test data profiles to be interpolated from the certification test data profiles, and creating a single neck response finite element model 30 for the crash test dummy 12 with a user-defined input parameter for the neck response finite element model 30 that defines a customized response. The method may also include the step of internally calibrating material cards for the neck using a parameter script to reproduce a certification D-plane rotation. The method may further include the step of varying finite element contact algorithm parameters of the neck response finite element model 20 for components of the neck.

Accordingly, the customized neck response finite element model 30 of the present invention can precisely represent any physical crash test dummy 12 passing certification, thus giving better control of D-plane rotation and hence the neck condyle moment of the neck for the crash test dummy 12. The customized neck response finite element model 30 of the present invention is a first of its kind model that bridges the gap between reality and simulation by taking variability into account. In addition, the customized neck response finite element model 30 of the present invention provides the framework for future finite element models and can be applied to other parts to better capture hardware behavior of the crash test dummy 12.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. A method of creating a customized neck response finite element model for a neck of a crash test dummy, said method comprising the steps of:
identifying two borderline sets of test data profiles of the neck that match with certification test data profiles for the neck of the crash test dummy;
varying material properties of components of the neck for the crash test dummy;
defining a mapping function to adjust the material properties and allowing intermediate sets of the test data profiles to be interpolated from the certification test data profiles; and
creating a single neck response finite element model for the neck of the crash test dummy with a user-defined input parameter for the neck response finite element model that defines a customized response.

2. A method as set forth in claim 1 wherein the customized response is equal to a D-plane rotation peak at a certification level for the neck.

3. A method as set forth in claim 1 including the step of internally calibrating material cards for the neck using a parameter script to reproduce a certification D-plane rotation.

4. A method as set forth in claim 1 including the step of setting the D-plane rotation between a maximum value and a minimum value of certification corridors for the crash test dummy.

5. A method as set forth in claim 4 wherein the D-Plane rotation is a default value corresponding to an average value of neck pendulum extension certification tests for the crash test dummy.

6. A method as set forth in claim 1 including the step of varying finite element contact algorithm parameters of the neck response finite element model for components of the neck.

7. A method as set forth in claim 6 wherein the finite element contact algorithm parameters include contact friction of the components.

8. A customized neck response finite element model for the neck of the crash test dummy created by the method as set forth in claim 1.

9. A method of creating a customized neck response finite element model for a neck of a crash test dummy, said method comprising the steps of:
setting a D-plane rotation between a maximum value and a minimum value of certification corridors for the crash test dummy;
identifying two borderline sets of test data profiles of the neck that match with certification test data profiles for the neck of the crash test dummy;
varying material properties of components of the neck for the crash test dummy;
defining a mapping function to adjust the material properties and allowing intermediate sets of the test data profiles to be interpolated from the certification test data profiles;
creating a single neck response finite element model for the neck of the crash test dummy with a user-defined input parameter for the neck response finite element model that defines a customized response; and
varying finite element contact algorithm parameters of the neck response finite element model for components of the neck.

10. A method as set forth in claim 9 wherein the customized response is equal to a D-plane rotation peak at a certification level for the neck.

11. A method as set forth in claim 9 including the step of internally calibrating material cards for the neck using a parameter script to reproduce a certification D-plane rotation.

12. A method as set forth in claim 9 wherein the D-Plane rotation is a default value corresponding to an average value of neck pendulum extension certification tests for the crash test dummy.

13. A method as set forth in claim 9 wherein the finite element contact algorithm parameters include contact friction of the components.

14. A customized neck response finite element model for the neck of the crash test dummy created by the method as set forth in claim 9.

15. A method of creating a customized neck response finite element model for a neck of a crash test dummy, said method comprising the steps of:
setting a D-plane rotation between a maximum value and a minimum value of certification corridors for the crash test dummy, wherein the D-Plane rotation is a default value corresponding to an average value of neck pendulum extension certification tests for the neck;
identifying two borderline sets of test data profiles of the neck that match with certification test data profiles for the neck;
varying material properties of components of the neck;
defining a mapping function to adjust the material properties and allowing intermediate sets of the test data profiles to be interpolated from the certification test data profiles; and
creating a single neck response finite element model for the neck of the crash test dummy with a user-defined input parameter for the neck response finite element model that defines a customized response, wherein the customized response is equal to a D-plane rotation peak at a certification level for the neck.

16. A method as set forth in claim 15 including the step of internally calibrating material cards for the neck using a parameter script to reproduce a certification D-plane rotation.

17. A method as set forth in claim 15 including the step of varying finite element contact algorithm parameters of the neck response finite element model for components of the neck, wherein the finite element contact algorithm parameters include contact friction of the components.

18. A customized neck response finite element model for the neck of the crash test dummy created by the method as set forth in claim 15.
